(19) United States
(12) Patent Application Publication
(10) Pub. No.: US 2008/0028092 A1
(43) Pub. Date: Jan. 31, 2008

(54) Method and device for customizing video communications

(76) Inventor: Bo Shen, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/494,928

(22) Filed: Jul. 28, 2006

(51) Int. Cl. G06F 15/16

(52) U.S. Cl. 709/231; 709/232

(57) ABSTRACT

A method for customizing video communications. An input video stream is received. It is determined whether to modify a visual appearance of the input video stream based on a user specification. If it is determined to modify the visual appearance of the input video stream, at least one modification function to apply to the input video stream is determined. The input video stream is modified according to the modification function, yielding a modified video stream. The modified video stream is then transmitted.

### BACKGROUND ART

With the advance of technology, day-to-day interpersonal communication is increasingly relying on mobile and multimedia-enabled devices. These devices provide various types of communication including voice phone calling, email messaging and text messaging. These types of communication provide users with many enhancements in communication, while including undesirable limitations.

For example, email communications do not reveal one's gender if so desired, or a voice phone call does not reveal one's appearance or surrounding environment. However, this is not the case for increasingly popular mobile handsets with image and video capabilities in addition to text and voice communication. The user can choose not to use the microphone or camera on the phone by just sending text messages or just doing a voice call so that no gender or appearance information is revealed. However, this binary yes/no choice limits the usefulness of the advancing technology. In particular, the use of video communications in mobile computing devices and other electronic devices is limited due to the limits based on the transmission of video streams.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram illustrating a system of devices operable to provide customized video communication, in accordance with an embodiment of the present invention.

FIG. 2 illustrates examples of video modification functions, in accordance with an embodiment of the present invention.

FIG. 3 is a flow chart illustrating a process for customizing video communications, in accordance with an embodiment of the present invention.

FIG. 4A is a flow chart illustrating a process of determining whether to modify visual appearance of the input video stream, in accordance with an embodiment of the present invention.

FIG. 4B is a flow chart illustrating a process of determining which modification function to apply to the input video stream, in accordance with an embodiment of the present invention.

The drawings referred to in this description should not be understood as being drawn to scale except if specifically noted.

### DESCRIPTION OF THE EMBODIMENTS

Various embodiments of the present invention, a method for customizing video communications, are described herein. An input video stream is received. It is determined whether to modify a visual appearance of the input video stream based on a user specification. If it is determined to modify the visual appearance of the input video stream, at least one modification function to apply to the input video stream is determined. The input video stream is modified according to the modification function, yielding a modified video stream. The modified video stream is then transmitted.

Reference will now be made in detail to the various embodiments of the invention, examples of which are illustrated in the accompanying drawings. While the invention will be described in conjunction with the various embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the various embodiments of the present invention, numerous specific details are set forth in order to provide a thorough understanding of the present invention. In other instances, well known methods, procedures, components, and circuits have not been described in detail as not to unnecessarily obscure aspects of the embodiments of the present invention.

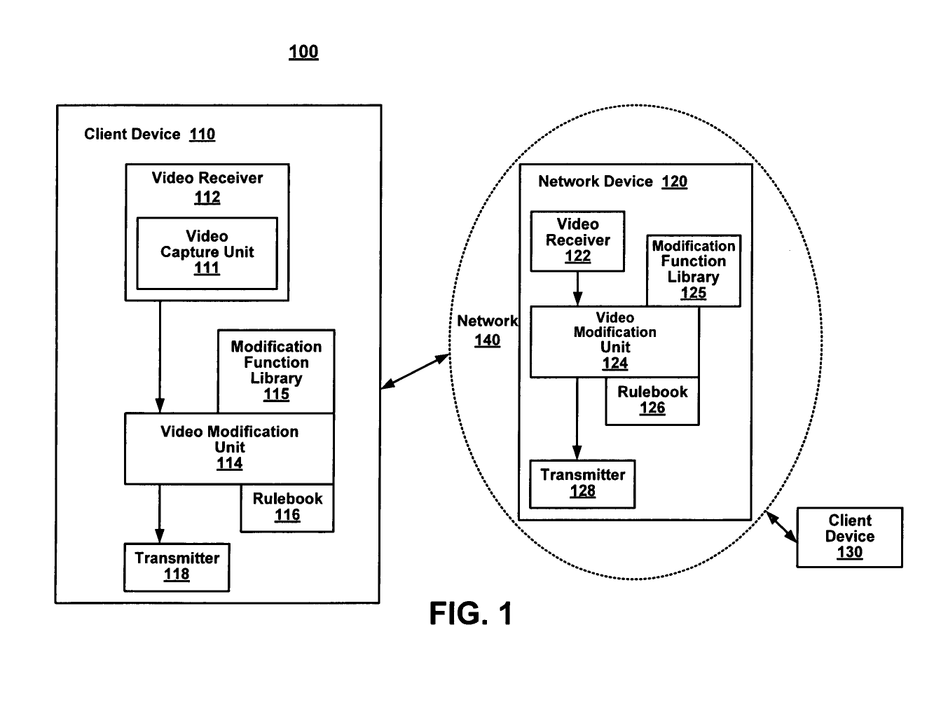

FIG. 1 is a block diagram illustrating a system 100 of devices operable to provide customized video communication, in accordance with an embodiment of the present invention. System 100 includes client device 110 and client device 130 communicatively coupled over network 140 in which network device 120 resides. At least one device of system 100 (e.g., client device 110 or network device 120) is operable to provide granular control personalization and anonymity of a video stream for use in interpersonal communication.

The described embodiments provide for the modification of visual information according to a user's preferences that achieves a fine granularity of information communication. For purposes of the present application, modification of a video stream refers to changing the visual appearance of the video stream. The modification of a video stream may also be referred to herein as scrubbing a video stream.

Moreover, it should be appreciated that the describe embodiments are applicable to any type of interpersonal video communication, including but not limited to real-time applications such as point-to-point videophone calls and videoconferencing, and pre-recorded video applications such as video mail. Furthermore, it should be appreciated that the video streams described herein are understood to include an associated audio portion, which itself may be subject to modification.

For example, embodiments described herein provide for the customization of a video phone call using a video-enabled mobile phone. For instance, the use of video phone call may not just for the call recipient to see the caller's face, but may also be used to convey a feeling of style. It is possible that a caller does not want the call recipient to exactly see his/her face during a video call session, but rather prefer to customize the video stream, e.g., using an artistically rendered sequence, to convey a presence. Other examples, modifications that can be made to a video stream include, but are not limited to, changing the luminance of the video stream, fading the color of the video stream, blurring the video stream, blocking the video stream, and artistically rendering the video stream.

In one embodiment, client device 110 includes video receiver 112, video modification unit 114 and transmitter 118. In one embodiment, client device 110 is a portable electronic device, such as a mobile phone or a portable computer system. However, it should be appreciated that client device 110 may be any type of electronic device that is capable of providing video communication functionality, such as a desktop computer system. Furthermore, it should be appreciated that client device 110 may include additional components, as understood by those of skill in the art. For example, client device 110 may include componentry for providing wireless communication. These additional components are not described herein so as to not obscure the described embodiments. Moreover, it should be appreciated that the described components of client device 110 may be implemented as hardware, software, firmware, or any combination thereof.

Video receiver 112 is operable to receive a video stream. In one embodiment, client device 110 also includes video capture unit 111 that is operable to record a video stream. For example, video capture unit 111 may be a video camera used in a mobile phone. Video receiver 112 receives the video stream captured at video capture unit 111.

In one embodiment, video receiver 112 forwards the video stream to video modification unit 114. Video modification unit 114 is operable to modify the visual appearance of the input video stream according to a user-defined modification function. In one embodiment, video modification unit 114 is a software application implemented on client device 110. For example, the software application video modification unit 114 may be included in client device 110 at the point of sale, or may be an after-market add-on available for purchase by a user.

In one embodiment, video modification unit 114 determines whether to modify the visual appearance of the input video stream based on a user specification. In one embodiment, video modification unit 114 receives the user specification as input from a user. This allows a user to indicate whether to modify a video stream at the time the video stream is transmitted to video modification unit 114. For example, the user specification may be included within the input video stream, e.g., within a data packet header. In another example, the prior to modifying the video stream, the user inputs a user specification as to whether to modify the video stream. The present embodiment allows a user to manually control whether a video stream is modified when the video stream is prepared for transmission to a recipient.

In another embodiment, client device 110 includes rulebook 116 accessible by video modification unit 114. Rulebook 116 is a database of rules that define whether to modify a video stream based on the satisfaction of a predetermined condition. In one embodiment, the rules of rulebook 116 are predefined. For example, a user may personalize rules according to the recipient, the time of day, the date (e.g., different modifications for holidays), and other user-defined criteria. In one embodiment, rulebook 116 includes default modification settings for video streams that are not subject to predefined rules.

In one embodiment, within client device 110, rulebook 116 works with an internal buddy list to control the visual scrubbing during the communication session. Rulebook 116 can be downloaded to client device 110 or directly compiled on the client device 110. With the help of the service providers in the infrastructure, it can also be managed and stored within the infrastructure, e.g., at rulebook 126.

In one embodiment, rulebook 116 may include rules that dictate that a video stream is modified based on the recipient of the video stream. In other words, a rule may indicate that a video communication with a particular person is subject to a particular modification. For example, a series of rules may dictate video communication with person A is, modified according to a blurring modification function, a conversation with person B is modified according to a color fading modification function, and a conversation with person C is not subject to any modification.

In another embodiment, the user specification or rulebook 116 can also be derived from social networking preferences that are specified in a Web link. For example, video can be blurred differently depending on the recipient's distance away from the sender in the social networking space. The information regarding the sender's social network may come from his/her social networking website.

In one embodiment, the video modification described herein is implemented within a mobile phone. In one embodiment, an automatic scrubbing decision can be made based on entries in the rulebook. The rulebook is pre-configured such that video communication with recipients in one's buddy list is not scrubbed. Otherwise, if the video communication is with a recipient not on the buddy list, the video communication is scrubbed to protect the visual anonymity of the caller. In another embodiment, the rulebook can be configured to choose different scrubbing styles for different people in the buddy list.

In another embodiment, the video modification described herein is implemented within a computer system providing videoconferencing functionality. Within a videoconference, it may be desirable for a user to allow a sender to see motions of a participant, e.g., a gesture for conveying a point in communication, but not identity of certain participant. For example, if a user not in this participant's buddy list joins a session, the participant's face is automatically scrubbed. The scrubbing choice can alter dynamically based on the dynamic situation during the conference. For example, a conference may be started with certain scrub setting and when new participants join, switches to another scrubbing setting based what has been specified in the rulebook.

In another embodiment, the video modification described herein is implemented in a video mail application. In this application, all the visual scrubbing functionalities can be implemented at the host of the video mail server since the sending and retrieving is mostly offline. The user can also set rules on how the media-rich mails can be retrieved. The scrubbing setting as stored along with his/her profile account in a rulebook. For example, a rule may be that if the video mail is forwarded to a third party, the mail is automatically scrubbed.

It should be appreciated that more advanced rules can also be added. For example, a location-based rule can be added if there is a global positioning system (GPS) unit in a mobile phone. Certain scrubbing can be automatically invoked based on the response from GPS location.

Video modification unit 114, upon determining that a video stream is to be modified, is configured to determine which modification function or functions to apply. In one embodiment, client device 110 includes modification function library 115 including a plurality of modification functions that are available by video modification unit 114. It should be appreciated that modification function library 115 may be configured to receive and store new modification functions. For example, a user of client device 110 may purchase new modification functions from a service-provider and download these new modification functions to client device 110 where they are stored in modification function library 115.

In one embodiment, an identifier of a selected modification function is received from a user. This allows a user to determine which modification function to apply at the time the video stream is transmitted to video modification unit 114. The present embodiment allows a user to manually control which modification function is applied to the video stream when the video stream is prepared for transmission to a recipient, and is user-driven. For example, when the user enters a location, e.g., in a museum, the user can manually (either volunteered or be forced to) invoke the scrubbing of the background regarding the location. In another example scenario, if the default scrubbing setting is to scrub in certain artistic style, but when the caller wants to show in detail some scene she captures, she can just push a button to deactivate scrubbing. In one advanced embodiment in which the client device has voice recognition unit built in, a voice command can be issued for this purpose. In another advanced embodiment in which a motion sensor is built in the client device, a motion-based command, e.g., one up-and-down shaking, can be issued for this purpose.

In another embodiment, the modification function or functions to be applied to the video stream are identified in rulebook 116. For example, as described above, a rule may indicate that a video communication with a particular person is subject to a particular modification.

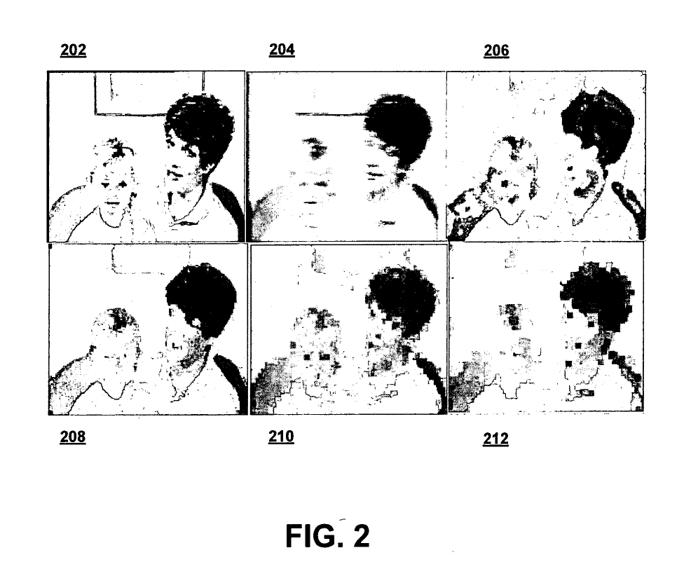

It should be appreciated that any number of modification functions may be applied to an input video stream. FIG. 2 illustrates examples of screen shots of videos modified according to different video modification functions, in accordance with an embodiment of the present invention. Screen shot 202 illustrates a non-modified original video clip. Screen shot 204 illustrates a screen shot of a modified video clip after a blurring modification function is applied. Screen shot 206 illustrates a screen shot of a modified video clip after a sponging modification function is applied. Screen shot 208 illustrates a screen shot of a modified video clip after an art-style modification function is applied. Screen shot 210 illustrates a screen shot of a modified video clip after a small-brush round-stroke style modification function is applied. Screen shot 212 illustrates a screen shot of a modified video clip after a big-brush round-stroke style modification function is applied.

It should be appreciated that the examples of FIG. 2 should not be considered an exhaustive list of modification functions, and that many other modification functions may be implemented. Moreover, these modification functions may have varying computational overheads such that some may require minimal computing power to execute while others may have a high degree of computational intensity. In one embodiment, simpler modification functions may be implemented or executed within video modification unit 114 of client device 110, while more complex modification functions may be implemented within video modification unit 124 of network device 120. For example, where client device 110 is a mobile phone, client device 110 may not have the computational power to perform complex modification functions. The modification function may then be applied at network device 120 that has a greater processing capability.

The variance and personalization of the style of the video communication enhances the user experience. For example, the user may prefer a unique visual appearance to the video stream during a session, similar to a user preference of a ring tone. However, in contrast with a ring tone, the visual appearance modification is determined by a user and is experienced by the video recipient.

The described embodiments also provide a user with the ability to anonymize their visual appearance without entirely sacrificing a video transmission. For example, a video session may be scrubbed according to the big-brush round-stroke style modification function shown in screen shot 212 to hide the identity of a caller while still providing the recipient with a video experience.

In other embodiments, the video modification unit 114 is operable to perform foreground/background segmentation, where a modification function can be selectively applied to one of the background portion of a video stream and the foreground portion of the video stream. For example, a caller may elect to scrub the background of the video stream such that the caller's face may be seen by the recipient, but the caller's location cannot be seen. Another example is where the caller may want to reveal his/her location but not his/her face, thus scrubbing only the foreground. Similarly, both the foreground portion and background portion may be scrubbed using different modification functions.

Video modification unit 114 is operable to generate a modified video stream by modifying the input video stream according to a modification function. As described above, a modification function may be selected at the time of video transmission or according to a predefined rule of rulebook 116. In one embodiment, video modification unit 114 accesses the appropriate modification function from modification function library 115, and modifies the input video stream according to the modification function, yielding a modified video stream.

Transmitter 118 is configured to transmit a video stream to a receiving device, e.g., client device 130. In one embodiment, transmitter 118 is configured to transmit a modified video stream to client device 130 via network 140. In another embodiment, where a selected modification function is not available at client device 110, transmitter 118 is configured to transmit the input video stream to network device 120 that is capable of performing the selected modification function. This would happen, for example, where a selected modification function is too computationally intensive for execution at client device 110.

It should be appreciated that client device 110 may not include any video modification functionality, and thus does not include video modification unit 114, modification function library 115, and rulebook 116. In the present embodiment, a user of client device 110 leverages the video modification functionality of network device 120. For example, as user may subscribe to a video modification service that is located remotely. The present embodiment may be used to provide legacy devices with video modification functionality.

In one embodiment, network device 120 includes video receiver 122, video modification unit 124 and transmitter 128. In one embodiment, network device 120 is a remote server. However, it should be appreciated that network device 120 may be any type of networking device, including but not limited to a router, a proxy, a base-station, a gateway, and any other computing device implemented on a network. Furthermore, it should be appreciated that network device 120 may include additional components, as understood by those of skill in the art. These additional components are not described herein so as to not obscure the described embodiments. Moreover, it should be appreciated that the described components of network device 120 may be implemented as hardware, software, firmware, or any combination thereof.

Video receiver 122 is operable to receive a video stream from client device 110. In one embodiment, video receiver 122 forwards the video stream to video modification unit 124. Video modification unit 124 is operable to modify the visual appearance of the input video stream according to a user-defined modification function. In one embodiment, video modification unit 124 is a software application implemented on network device 120. For example, the software application video modification unit 124 may be included in network device 120 at the point of sale, or may be an after-market add-on available for purchase by a user. It should be appreciated that video modification unit 124 operates is a similar manner as video modification unit 114, as described above.

In one embodiment, video modification unit 124 determines whether to modify the visual appearance of the input video stream based on a user specification. In one embodiment, video modification unit 124 receives the user specification as input from a user. This allows a user to indicate whether to modify a video stream at the time the video stream is transmitted to video modification unit 124. For example, the user specification may be included within the input video stream, e.g., within a data packet header. In another example, the prior to modifying the video stream, the user inputs a user specification as to whether to modify the video stream. The present embodiment allows a user to manually control whether a video stream is modified when the video stream is prepared for transmission to a recipient.

In another embodiment, network device 120 includes rulebook 126 accessible by video modification unit 124. Rulebook 126 is a database of rules that define whether to modify a video stream based on the satisfaction of a predetermined condition. In one embodiment, the rules of rulebook 126 are predefined. For example, a user may personalize rules according to the recipient, the time of day, the date (e.g., different modifications for holidays), and other user-defined criteria. In one embodiment, rulebook 126 includes default modification settings for video streams that are not subject to predefined rules.

In one embodiment, rulebook 126 may include rules that dictate that a video stream is modified based on the recipient of the video stream. In other words, a rule may indicate that a video communication with a particular person is subject to a particular modification. For example, a series of rules may dictate video communication with person A is modified according to a blurring modification function, a conversation with person B is modified according to a color fading modification function, and a conversation with person C is not subject to any modification.

Video modification unit 124, upon determining that a video stream is to be modified, is configured to determine which modification function or functions to apply. In one embodiment, network device 120 includes modification function library 125 including a plurality of modification functions that are available by video modification unit 124. It should be appreciated that modification function library 125 may be configured to receive and store new modification functions. For example, a user of network device 120 may purchase new modification functions from a service-provider and download these new modification functions to client device 110 where they are stored in modification function library 125.

In one embodiment, an identifier of a selected modification function is received from a user. This allows a user to determine which modification function to apply at the time the video stream is transmitted to video modification unit 124. The present embodiment allows a user to manually control which modification function is applied to the video stream when the video stream is prepared for transmission to a recipient.

In another embodiment, the modification function or functions to be applied to the video stream are identified in rulebook 126. For example, as described above, a rule may indicate that a video communication with a particular person is subject to a particular modification.

It should be appreciated that any number of modification functions may be applied to an input video stream as described above and illustrated by the exemplary screen shots of FIG. 2 as well as any other modification function. Moreover, these modification functions may have varying computational overheads such that some may require minimal computing power to execute while others may have a high degree of computational intensity. In one embodiment, simpler modification functions may be implemented or executed within video modification unit 114 of client device 110, while more complex modification functions may be implemented within video modification unit 124 of network device 120. For example, where client device 110 is a mobile phone, client device 110 may not have the computational power to perform complex modification functions. The modification function may then be applied at network device 120 that has a greater processing capability.

The variance and personalization of the style of the video communication enhances the user experience. The described embodiments also provide a user with the ability to anonymize their visual appearance without entirely sacrificing a video transmission.

Video modification unit 124 is operable to generate a modified video stream by modifying the input video stream according to a modification function. As described above, a modification function may be selected at the time of video transmission or according to a predefined rule of rulebook 126. In one embodiment, video modification unit 124 accesses the appropriate modification function from modification function library 125, and modifies the input video stream according to the modification function, yielding a modified video stream.

Transmitter 128 is configured to transmit a video stream to a receiving device, e.g., client device 130. In one embodiment, transmitter 128 is configured to transmit a modified video stream to client device 130 via network 140.

Client device 130 is an electronic device that is operable to visually render the modified video stream. In one embodiment, client device 130 is a portable electronic device, such as a video-enabled mobile phone or a portable computer system. However, it should be appreciated that client device 130 may be any type of electronic device that is capable of providing video communication functionality, such as a desktop computer system.

System 100 illustrates devices and components for providing the customization of video streams for use in inter-personal communications. It should be appreciated that various embodiments require different combinations of the above-describe components. For example, in one embodiment, client device 110 is configured to provide all video modification functionality, and thus network device 120 is optional. In another embodiment, client device is not able to provide any video modification functionality, and transmits the input video stream to network device 120 for performing video modification. In the present embodiment, video modification unit 114, modification function library 115, and rulebook 116 are optional. In another embodiment, client device 110 and network device 120 are both operable to provide video modification functionality, where network device 120 has more computational power. In the present embodiment, client device 110 is configured to perform simple video modification, while more complex video modification is performed at network device 120.

It should be appreciated that embodiments may be implemented at other computing devices communicatively coupled over network 140. For example, client device 130 may be configured to perform video modification in an input video stream.

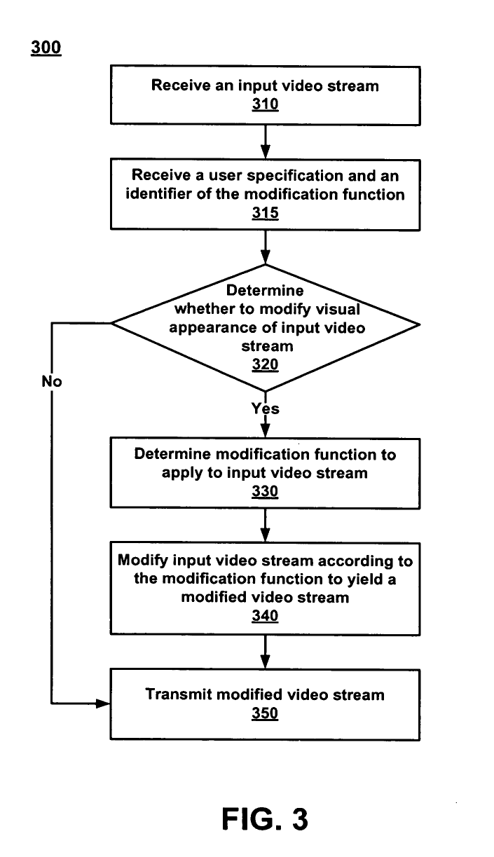

FIG. 3 is a flow chart illustrating a process 300 for customizing video communications, in accordance with an embodiment of the present invention. In one embodiment, process 300 is carried out by processors and electrical components under the control of computer readable and computer executable instructions. The computer readable and computer executable instructions reside, for example, in data storage features such as computer usable volatile and non-volatile memory. However, the computer readable and computer executable instructions may reside in any type of computer readable medium. Although specific steps are disclosed in process 300, such steps are exemplary. That is, the embodiments of the present invention are well suited to performing various other steps or variations of the steps recited in FIG. 3. In one embodiment, process 300 is performed by client device 110 of FIG. 1. In another embodiment, process 300 is performed by network device 120 of FIG. 1. In another embodiment, process 300 is performed by client device 110 and network device 120.

At step 310 of process 300, an input video stream is received. In one embodiment, the input video stream is received at video receiver 112. In another embodiment, the input video stream is received at video receiver 122.

At step 315, a user specification and an identifier of the modification function are received. It should be appreciated that step 315 is optional.

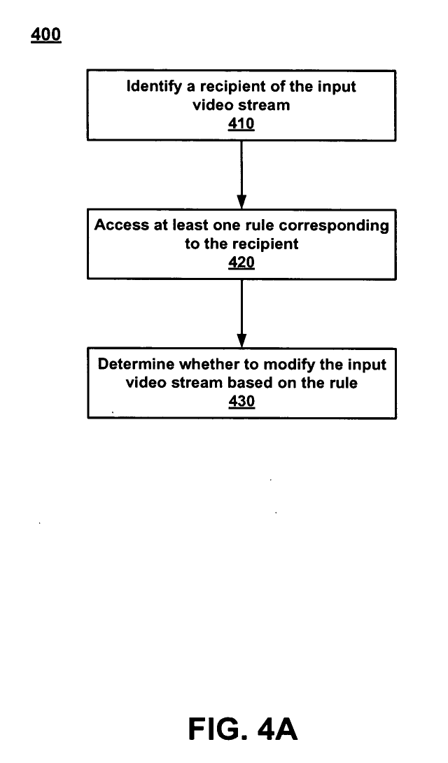

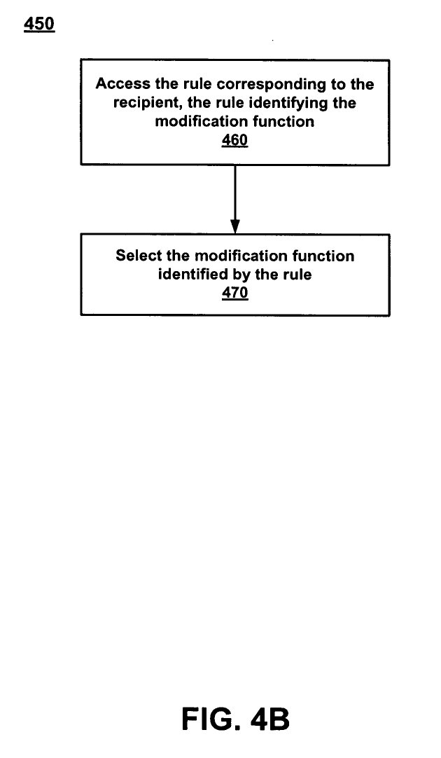

At step 320, it is determined whether to modify a visual appearance of the input video stream based on a user specification. In one embodiment, this determination is made at video modification unit 114. In another embodiment, this determination is made at video modification unit 124. In one embodiment, this determination is based on the user specification as received at step 315. In another embodiment, the determination is made according to process 400 of FIG. 4A.

FIG. 4A is a flow chart illustrating a process 400 of determining whether to modify visual appearance of the input video stream, in accordance with an embodiment of the present invention. At step 410, a recipient of the input video stream is determined. In one embodiment, the recipient is identified in a packet header of the input video stream. At step 420, at least one rule corresponding to the recipient is accessed. In one embodiment, the rule is accessed from a rulebook, e.g., rulebook 116 or rulebook 126.

At step 430, it is determined whether to modify the input video stream based on the rule. For example, the rule may indicate that video streams for transmission to person A are subject to video modification while video streams for transmission to person B are not subject to video modification.

With reference to FIG. 3, if it is determined at step 320 to not modify the input video stream, process 300 proceeds to step 350. Alternatively, if it is determined to modify the visual appearance of the input video stream, process 300 proceeds to step 330.

At step 330, at least one modification function to apply to the input video stream is determined. In one embodiment, this determination is made at video modification unit 114. In another embodiment, this determination is made at video modification unit 124. In one embodiment, this determination is based on the identifier as received at step 315. In another embodiment, the determination is made according to process 450 of FIG. 4B.

FIG. 4B is a flow chart illustrating a process 450 of determining which modification function to apply to the input video stream, in accordance with an embodiment of the present invention. At step 460, the rule corresponding to the recipient is accessed, where the rule identifies the modification function. At step 470, the modification function identified by the rule is selected.

It should be appreciated that the modification function may be selected from any available modification function, including but not limited to changing luminance, fading color, blurring, blocking, and artistic rendering.

With reference to FIG. 3, at step 340, the input video stream is modified according to the modification function, yielding a modified video stream. In one embodiment, the modification is made at video modification unit 114. In another embodiment, the modification is made at video modification unit 124.

At step 350, the modified video stream is transmitted. In one embodiment, the modified video stream is transmitted by transmitter 118 to client device 130 via network 140. In another embodiment, the modified video stream is transmitted by transmitter 128 to client device 130 via network 140.

In summary, the described embodiments provide for granular control of video streams used in inter-personal communications. Visual information can I be transmitted in a scrubbed/modified form according to user's preferences, achieving a finer granularity of information communication. Finer granularity of information also indicates finer granularity of anonymity in communication. Moreover, from a personalization perspective, the use of video phone call may not just for the recipient to see the caller's face, but also for the caller to convey a sense of style and mood. Also, the described embodiments allow a caller to protect anonymity of his/her face while still providing a video stream to convey a presence.

Various embodiments of the present invention, a method and device for customizing video communications, are described herein. While the present invention has been described in particular embodiments, it should be appreciated that the present invention should not be construed as limited by such embodiments, but rather construed according to the following claims.

What is claimed is:

1. A method for customizing video communications, said method comprising:
receiving an input video stream;
determining whether to modify a visual appearance of said input video stream based on a user specification;
if it is determined to modify said visual appearance of said input video stream, determining at least one modification function to apply to said input video stream;
modifying said input video stream according to said modification function, yielding a modified video stream; and
transmitting said modified video stream.

2. The method as recited in claim 1 further comprising receiving said user specification and an identifier of said modification function.

3. The method as recited in claim 1 wherein said user specification and an identifier of said modification function are comprised within a rulebook, such that said determining whether to modify said input video stream comprises:
identifying a recipient of said input video stream;
accessing at least one rule corresponding to said recipient; and
determining whether to modify said input video stream based on said rule.

4. The method as recited in claim 3 wherein said modifying said input video stream according to said modification function, yielding said modified video stream, comprises:
accessing said rule corresponding to said recipient, said rule identifying said modification function; and
selecting the modification function identified by said rule.

5. The method as recited in claim 1 wherein said modifying said input video stream according to said modification function, yielding said modified video stream, is performed at a client device.

6. The method as recited in claim 1 wherein said modifying said input video stream according to said modification function, yielding said modified video stream, is performed at a network device communicatively coupled to a client device, said input video stream originating at said client device.

7. The method as recited in claim 1 wherein said modification function is selected from a plurality of modification functions consisting essentially of: changing luminance, fading color, blurring, blocking, and artistic rendering.

8. An electronic device comprising:
a video receiver for receiving an input video stream;
a video modification unit for determining whether to modify a visual appearance of said input video stream based on a user specification, for determining at least one modification function to apply to said input video stream if it is determined to modify said visual appearance of said input video stream, and for generating a modified video stream by modifying said input video stream according to said modification function; and
a transmitter for transmitting said modified video stream.

9. The electronic device as recited in claim 8 wherein said video modification unit is configured to receive said user specification and an identifier of said modification function.

10. The electronic device as recited in claim 8 wherein said user specification and an identifier of said modification function are comprised within a rulebook accessible by said video modification unit, wherein said video modification unit is operable to identify a recipient of said input video stream, access at least one rule corresponding to said recipient, and determine whether to modify said input video stream based on said rule.

11. The electronic device as recited in claim 10 wherein said modification unit is operable to access said rule corresponding to said recipient, said rule identifying said modification function, and to select the modification function identified by said rule.

12. The electronic device as recited in claim 8 wherein said electronic device is a client device and wherein said video receiver comprises a video capture unit for capturing said input video stream.

13. The electronic device as recited in claim 8 wherein said electronic device is a network device and wherein said video receiver is for receiving said input video signal from a client device communicatively coupled to said network device over a network.

14. The electronic device as recited in claim 8 wherein said modification function is selected from a plurality of modification functions consisting essentially of: changing luminance, fading color, blurring, blocking, and artistic rendering.

15. A computer-usable medium having computer-readable program code embodied therein for causing a computer system to perform a method for customizing video communications, the method comprising:
receiving an input video stream from an electronic device;
determining whether to modify a visual appearance of said input video stream based on a user specification;
if it is determined to modify said visual appearance of said input video stream, determining at least one modification function to apply to said input video stream;
modifying said input video stream according to said modification function, yielding a modified video stream; and
transmitting said modified video stream.

16. The computer-usable medium as recited in claim 15 wherein said method further comprises receiving said user specification and an identifier of said modification function.

17. The computer-usable medium as recited in claim 15 wherein said user specification and an identifier of said modification function are comprised within a rulebook, such that said determining whether to modify said input video stream comprises:
identifying a recipient of said input video stream;
accessing at least one rule corresponding to said recipient; and
determining whether to modify said input video stream based on said rule.

18. The computer-usable medium as recited in claim 17 wherein said modifying said input video stream according to said modification function, yielding said modified video stream, comprises:
accessing said rule corresponding to said recipient, said rule identifying said modification function; and
selecting the modification function identified by said rule.

19. The computer-usable medium as recited in claim 15 wherein said modifying said input video stream according to said modification function, yielding said modified video stream, is performed at a client device.

20. The computer-usable medium as recited in claim 15 wherein said modifying said input video stream according to said modification function, yielding said modified video stream, is performed at a network device communicatively coupled to a client device, said input video stream originating at said client device.
